(19) United States
(12) Patent Application Publication
(10) Pub. No.: US 2017/0121082 A1
(43) Pub. Date: May 4, 2017

(54) Stand-Up Container

(71) Applicant: Dow Global Technologies LLC, Midland, MI (US)

(72) Inventors: Rashi Tiwari, Freeport, TX (US); Robert L. McGee, Midland, MI (US); Timothy J. Pope, Missouri City, TX (US); Lamy J. Chopin, III, Freeport, TX (US); Jose Eduardo Ruiz, Freeport, TX (US)

(21) Appl. No.: 15/336,220

(22) Filed: Oct. 27, 2016

Related U.S. Application Data
(60) Provisional application No. 62/248,552, filed on Oct. 30, 2015.

(51) Int. Cl. B65D 75/00; B65D 75/58; B32B 27/32; B65D 41/00; B32B 27/08; B65D 75/56; B65D 30/20

(52) U.S. Cl. CPC B65D 75/008; B65D 75/566; B65D 75/5883; B65D 31/10; B65D 41/00; B65D 75/563; B32B 27/08; B32B 27/32; B32B 2307/72; B32B 2439/40

(57) ABSTRACT

The present disclosure provides a flexible container. In an embodiment, the flexible container includes
A. a front panel, a rear panel, a first gusseted side panel, and a second gusseted side panel, the gusseted side panels adjoining the front panel and the rear panel along peripheral seals to form a chamber, each panel is a multilayer film having at least three layers, each multilayer film comprising
   (i) an outermost layer comprising a high density polyethylene (HDPE) having a density from greater than 0.94 g/cc to 0.98 g/cc,
   (ii) a core layer comprising a core ethylene-based polymer having a density from 0.908 g/cc to less than 0.93 g/cc,
   (iii) an innermost seal layer comprising a seal ethylene-based polymer having a density from 0.86 g/cc to 0.92 g/cc; and
B. each panel includes a bottom face comprising two opposing peripheral tapered seals, each peripheral tapered seal extending from a respective peripheral seal.

### BACKGROUND

The present disclosure is directed to a stand-up container made from a flexible multilayer film.

A stand-up container is a container made from flexible polymeric film, the container having the ability to stand upright on a horizontal surface. Stand-up containers are also known as stand-up pouches or “SUPs.” In order to stand upright, the flexible polymeric film requires sufficient stiffness, so that when formed into the SUP, the SUP is capable of (i) standing upright without losing its shape, (ii) not distorting during content discharge, and (iii) not collapsing under its own weight. SUPs are used in a wide range of end-use applications and are common-place to today's consumers.

In addition to stiffness, SUP flexible polymeric film also requires mechanical properties, such as high drop impact strength, high tear strength, puncture resistance, sealability, and extrudability.

Current SUPs, suffer from high failure rates due to vibration during shipping and poor drop strength. Typical SUP film with a nylon layer(s) provides toughness and durability, yet can exhibit high vibration fail rates and high drop fail rates. Compounding these shortcomings, the art recognizes the need for all-polyethylene SUP film in order to advance sustainability and recyclability. Nylon-containing SUP film is difficult to recycle economically.

A need exists for flexible multilayer film for producing SUPs that improves vibration resistance and drop strength while not adversely affecting other film properties. A need further exists for an SUP multilayer film made from all-polyethylene with the foregoing improved properties.

### SUMMARY

The present disclosure provides a flexible container. In an embodiment, the flexible container includes

A. a front panel, a rear panel, a first gusseted side panel, and a second gusseted side panel, the gusseted side panels adjoining the front panel and the rear panel along peripheral seals to form a chamber, each panel is a multilayer film having at least three layers, each multilayer film comprising
(i) an outermost layer comprising a high density polyethylene (HDPE) having a density from greater than 0.94 g/cc to 0.98 g/cc,
(ii) a core layer comprising a core ethylene-based polymer having a density from 0.908 g/cc to less than 0.93 g/cc,
(iii) an innermost seal layer comprising a seal ethylene-based polymer having a density from 0.86 g/cc to 0.92 g/cc; and

B. each panel includes a bottom face comprising two opposing peripheral tapered seals, each peripheral tapered seal extending from a respective peripheral seal.

The present disclosure provides another container. In an embodiment, the flexible container includes:

A. a front panel, a rear panel, a first gusseted side panel, and a second gusseted side panel, the gusseted side panels adjoining the front panel and the rear panel along peripheral seals to form a chamber, each panel is a multilayer film having at least three layers, each multilayer film comprising
(i) an outermost layer comprising a high density polyethylene (HDPE) having a density from greater than 0.94 g/cc to 0.98 g/cc,
(ii) a core layer comprising a core ethylene-based polymer having a density from 0.908 g/cc to less than 0.93 g/cc,
(iii) an innermost seal layer comprising a seal ethylene-based polymer having a density from 0.86 g/cc to 0.92 g/cc;

B. each panel includes a bottom face comprising two opposing peripheral tapered seals, each peripheral tapered seal extending from a respective peripheral seal, each peripheral tapered seal comprising an inner edge, the peripheral tapered seals converging at a bottom seal area;

C. the front panel bottom face comprises a first line defined by the inner edge of the first peripheral tapered seal and a second line defined by the inner edge of the second peripheral tapered seal inner edge, the first line intersecting the second line at an apex point in the bottom seal area;

D. the front panel bottom face has a bottom distalmost inner seal point on the inner edge; and

E. the apex point is separated from the bottom distalmost inner seal point by a distance from 0 mm to less than 8.0 mm.

### BRIEF DESCRIPTION OF THE DRAWINGS

FIG. 1 is a perspective view of a filled flexible container having top and bottom flexible handles in a rest position.

FIG. 2 is a bottom plan view of the flexible container of FIG. 1.

FIG. 3 is a perspective view of the flexible container of FIG. 1 shown with its top and bottom handles extended.

FIG. 4 is a top plan view of the flexible container of FIG. 1.

FIG. 5 is a side plan view of the flexible container of FIG. 1 in an inverted position for transferring the contents.

FIG. 6 is a cross-sectional view taken along the line 6-6 of FIG. 1.

FIG. 7 is a perspective view of the container of FIG. 1 in a collapsed configuration.

FIG. 8 is an enlarged view of the bottom seal area of FIG. 7.

### DEFINITIONS

The numerical ranges disclosed herein include all values from, and including, the lower value and the upper value. For ranges containing explicit values (e.g., 1 or 2, or 3 to 5, or 6, or 7) any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An “ethylene-based polymer” is a polymer that contains greater than 50% by weight polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The term “ethylene-based polymer” and “polyethylene” may be used interchangeably. Non-limiting examples of ethylene-based polymer (polyethylene) include low density polyethylene (LDPE) and linear polyethylene. Non-limiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, and high density polyethylene (HDPE).

Generally, polyethylene, such as listed above, may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations.

“High density polyethylene” (or “HDPE”) is an ethylene homopolymer or an ethylene/α-olefin copolymer with at least one C₄-C₁₀ α-olefin comonomer, or C₄ α-olefin comonomer and a density from greater than 0.94 g/cc, or 0.945 g/cc, or 0.95 g/cc, or 0.955 g/cc, to 0.96 g/cc to 0.97 g/cc, or 0.98 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE are DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell) as well as HDPE products from Borealis, Ineos, and ExxonMobil.

“Linear low density polyethylene” (or “LLDPE”) is a linear ethylene-α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆ -C₈ α-olefin comonomer. LLDPE is characterized by little, if any, long chain branching, in contrast to conventional LDPE. LLDPE has a density from 0.910 g/cc, or 0.915 g/cc, or 0.920 g/cc, or 0.925 g/cc to 0.930 g/cc, or 0.935 g/cc, or 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

ULDPE and VLDPE each is a linear ethylene-α-olefin copolymer containing heterogeneous short-chain branching distribution comprising units derived from ethylene and units derived from at least one C₃-C₁₀ α-olefin comonomer, or at least one C₄-C₈ α-olefin comonomer, or at least one C₆ -C₈ α-olefin comonomer. ULDPE and VLDPE each have a density from 0.885 g/cc, or 0.90 g/cc to 0.915 g/cc. Nonlimiting examples of ULDPE and VLDPE include ATTANE™ ultra low density polyethylene resins (available form The Dow Chemical Company) and FLEXOMER™ very low density polyethylene resins (available from The Dow Chemical Company).

“Multi-component ethylene-based copolymer” (or “EPE”) comprises units derived from ethylene and units derived from at least one C₃-C₁₀ α-olefin comonomer, or at least one C₄-C₈ α-olefin comonomer, or at least one C₆ -C₈ α-olefin comonomer, such as described in patent references U.S. Pat. No. 6,111,023, U.S. Pat. No. 5,677,383, and U.S. Pat. No. 6,984,695. EPE resins have a density from 0.905 g/cc, or 0.908 g/cc, or 0.912 g/cc, or 0.920 g/cc to 0.926 g/cc, or 0.929 g/cc, or 0.940 g/cc, or 0.962 g/cc. Nonlimiting examples of EPE resins include ELITE™ enhanced polyethylene (available from The Dow Chemical Company), ELITE AT™ advanced technology resins (available from The Dow Chemical Company), SURPASS™ Polyethylene (PE) Resins (available from Nova Chemicals), or SMART™ (available from SK Chemicals Co.).

Olefin block copolymers (OBC) are ethylene-α-olefin multi-block copolymers comprising units derived from ethylene and units derived from at least one C₃-C₁₀ α-olefin comonomer, or at least one C₄-C₈ α-olefin comonomer, or at least one C₆ -C₈ α-olefin comonomer, such as INFUSE™ (available from The Dow Chemical Company) as described in U.S. Pat. No. 7,608,668. OBC resins have a density from 0.866 g/cc, or 0.870 g/cc, or 0.875 g/cc, or 0.877 g/cc to 0.880 g/cc, or 0.885, or 0.890 g/cc.

Single-site catalyzed linear low density polyethylenes (m-LLDPE) are linear ethylene-α-olefin copolymers containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. m-LLDPE has density from 0.913 g/cc, or 0.918 g/cc, or 0.920 g/cc, to 0.925 g/cc, or 0.940 g/cc. Nonlimiting examples of m-LLDPE include EXCEED metallocene PE (available from ExxonMobil Chemical), LUFLEXEN™ m-LLDPE (available from LyondellBasell), and ELTEX™ PF m-LLDPE (available from Ineos Olefins & Polymers).

Ethylene plastomers/elastomers are substantially linear, or linear, ethylene-α-olefin copolymers containing homogeneous short-chain branching distribution comprising units derived from ethylene and units derived from from at least one C₃-C₁₀ α-olefin comonomer, or at least one C₄-C₈ α-olefin comonomer, or at least one C₆-C₈ α-olefin comonomer. Ethylene plastomers/elastomers have a density from 0.870 g/cc, or 0.880 g/cc, of 0.890 g/cc to 0.900 g/cc, or 0.902 g/cc, or 0.904 g/cc, or 0.909 g/cc, or 0.910 g/cc, or 0.917 g/cc. Nonlimiting examples of ethylene plastomers/elastomers include AFFINITY™ plastomers and elastomers (available from The Dow Chemical Company), EXACT™ Plastomers (available from ExxonMobil Chemical), Tafmer (available from Mitsui). Nexlene (available from SK Chemicals Co.), and Lucene (available LG Chem Ltd.).

The term “low density polyethylene,” or “LDPE,” consists of ethylene homopolymer, or ethylene-α-olefin copolymer comprising at least one C₃-C₁₀ α-olefin, preferably C₃-C₄ that has a density from 0.915 g/cc to 0.940 g/cc, contains long chain branching with broad MWD. LDPE is typically produced by way of high pressure free radical polymerization (tubular reactor or autoclave with free radical initiator). LDPE examples include MarFlex (Chevron Phillips), LUPOLEN™ (LyondellBasell), as well as LDPE products from Borealis, Ineos, ExxonMobil, and others.

An “olefin-based polymer,” as used herein, is a polymer that contains more than 50 mole percent polymerized olefin monomer (based on total amount of polymerizable monomers), and optionally, may contain at least one comonomer. Non-limiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

A “propylene-based polymer” is a polymer that contains more than 50 weight percent polymerized propylene monomer (based on the total amount of polymerizable monomers) and, optionally, may contain at least one comonomer.

### Test Methods

2% Secant Modulus (machine direction, MD and cross direction CD) is measured according to ASTM D882-10 (average of five film samples in each direction; each sample “1 in×6 in” or 25 mm×150 mm).

Density is determined in accordance with ASTM D792.

Elmendorf Tear Strength (MD and CD) is measured according to ASTM D 1922-09 (average of 15 film samples in each direction; each sample “3 in×2.5 in” half moon shape).

Melt Flow Rate or “MFR” is determined according to ASTM D1238 (230° C., 2.16 kg).

Melt index (or “MI”) is determined according to ASTM D1238 (190° C., 2.16 kg).

The term “molecular weight distribution” or “MWD” is the ratio of weight average molecular weight to number average molecular weight (Mw/Mn). Mw and Mn are determined according to conventional gel permeation chromatography (GPC).

Tm or “melting point” or “Tm,” as used herein (also referred to as a melting peak in reference to the shape of the plotted DSC curve) is typically measured by the DSC (Differential Scanning Calorimetry) technique for measuring the melting points or peaks of polyolefins as described in U.S. Pat. No. 5,783,638. It should be noted that many blends comprising two or more polyolefins will have more than one melting point or peak, many individual polyolefins will comprise only one melting point or peak.

Tensile Strength and Tensile Energy to Break (MD and CD) are measured in accordance with ASTM D882-10 (average of five film samples in each direction; each sample “1 in×6 in” or 25 mm×150 mm).

### DETAILED DESCRIPTION

### 1. Multilayer Film

The present disclosure provides a multilayer film. In an embodiment, a multilayer film is provided and includes at least three layers—(i) an outermost layer, (ii) one or more core layers, and (iii) an innermost seal layer. The multilayer film is flexible, resilient, deformable, and pliable. The outermost layer (i) and the innermost seal layer (iii) are surface layers with the one or more core layers (ii) sandwiched between the surface layers. The outermost layer may include a (a-i) a HDPE, (b-ii) a propylene-based polymer or combinations of (a-i) and (b-ii), alone, or with other olefin-based polymers such as LDPE. Suitable propylene-based polymers include propylene homopolymer, random propylene/α-olefin copolymer (majority amount propylene with less than 10 wt % ethylene comonomer), and propylene impact copolymer (heterophasic propylene/ethylene copolymer rubber phase dispersed in a matrix phase).

With the one or more core layers (ii), the number of total layers in the present multilayer film can be from three layers (one core layer), or four layers (two core layers), or five layers (three core layers, or six layers (four core layers), or seven layers (five core layers) to eight layers (six core layers), or nine layers (seven core layers), or 10 layers (eight core layers), or 11 layers (nine core layers), or more.

The multilayer film has a thickness from 75 microns, or 100 microns, or 125 microns, or 150 microns to 200 microns, or 250 microns or 300 microns or 350 microns.

The multilayer can be (i) coextruded, (ii) laminated, or (iii) a combination of (i) and (ii). In an embodiment, the multilayer film is a coextruded multilayer film.

In an embodiment, the multilayer film has
(i) an outermost layer composed of a HDPE having a density from greater than 0.94 g/cc to 0.98 g/cc,
(ii) one or more core layers composed of a core ethylene-based polymer having a density from 0.908 g/cc to less than 0.93 g/cc; and
(iii) an innermost seal layer composed of a seal ethylene-based polymer having a density from 0.86 g/cc to 0.92 g/cc.

### A. Outermost Layer

In an embodiment, the outermost layer includes a HDPE. In a further embodiment, the HDPE is an EPE.

In an embodiment, the outermost layer includes a blend of HDPE and a LDPE.

### B. Core Layer

The present multilayer film includes one or more core layers. Each core layer includes one or more linear or substantially linear ethylene-based polymers or block copolymers having a density from 0.908 g/cc, or 0.912 g/cc, or 0.92 g/cc, or 0.921 g/cc, to 0.925 g/cc, or less than 0.93 g/cc.

In an embodiment, each of the one or more core layers includes one or more ethylene/C₃-C₈ α-olefin copolymers selected from:
(i) LLDPE, ULDPE, VLDPE, EPE, OBC, plastomers/elastomers, or m-LLDPE and having
(ii) an MI from 0.5 g/10 min, or 0.8 g/10 min, or 1.0 g/10 min, or 1.5 g/10 min, or 2.0 g/10 min, or 3 g/10 min, or 5 g/10 min, or 7 g/10 min to 8 g/10 min, or 9 g/10 min, or 10 g/10 min, or 11 g/10 min, or 12 g/10 min, or 13 g/10 min, or 14 g/10 min, or 15 g/10 min.

### C. Seal Layer

The present multilayer film includes an innermost seal layer (or seal layer). The seal layer includes one or more seal ethylene-based polymer having a density from 0.86 g/cc, or 0.87 g/cc, or 0.875 g/cc, or 0.88 g/cc, or 0.89 g/cc, to 0.90 g/cc, or 0.902 g/cc, or 0.91 g/cc, or 0.92 g/cc.

In an embodiment, the seal layer includes one or more ethylene/C₃-C₈ α-olefin copolymer selected from:
(i) EPE, plastomers/elastomers, or m-LLDPE; and having
(ii) an MI from 0.5 g/10 min, or 0.8 g/10 min, or 1.0 g/10 min, or 1.5 g/10 min, or 2.0 g/10 min, or 3 g/10 min, or 5 g/10 min, or 7 g/10 min to 8 g/10 min, or 9 g/10 min, or 10 g/10 min, or 11 g/10 min, or 12 g/10 min, or 13 g/10 min, or 14 g/10 min, or 15 g/10 min.

### D. Additives

Each layer in the multilayer film may include one or more optional additives. Non-limiting examples of suitable additives include stabilizers, slip additives, antiblocking additives, process aids, clarifiers, nucleators, pigments or colorants, fillers and reinforcing agents. It is particularly useful to choose additives and polymeric materials that have suitable organoleptic and or optical properties.

In an embodiment, the seal ethylene-based polymer has a first melt temperature, Tm1, less than 105° C. The HDPE in the outermost layer has a second melt temperature, Tm2, and Tm2-Tm1 is from 20° C., or 25° C., or 30° C. to 35° C., or 40° C., or 45° C., or 50° C.

In an embodiment, the multilayer film contains from 5 vol %, or 10 vol %, or 15 vol %, or 20 vol %, to 25 vol %, to 30 vol %, or 35 vol %, or 40 vol %, or 45% HDPE. In a further embodiment, the multilayer film contains from 10 vol %, or 15 vol %, to 20 vol %, or 25 vol %, or 30% vol % HDPE.

In an embodiment, the multilayer film includes
(i) an outermost layer composed of HDPE with an MI from 0.5 g/10 min or 1.0 g/10 min to 1.5 g/10 min,
(ii) a core layer composed of an ethylene/C₄-C₈ α-olefin copolymer having a density from 0.91 g/cc to 0.93 g/cc and a MI from 0.5 g/10 min, or 1.0 g/10 min to 1.5 g/10 min, and
(iii) an innermost seal layer composed of an ethylene/C₄-C₈ α-olefin copolymer having a density from 0.88 g/cc to 0.91 g/cc and a MI from 0.5 g/10 min, or 1.0 g/10 min to 1.5 g/10 min (hereafter Film 1).

In an embodiment, Film 1 has a thickness from 100 microns and 250 microns and Film 1 has one, some, or all of the following properties:
(i) a 2% secant modulus from 200 MPa, or 250 MPa to 300 MPa, or 350 MPa;
(ii) a tensile energy to break from 20 Joules (J), or 25 J, or 30 J to 35 J, or 40 J; and
(iii) an Elmendorf tear strength from 4.0 Newtons (N)/25 microns, or 5.0 N/25 microns, or 6.0 N/25 microns, to 7.0 N/25 microns, or 8.0 N/25 microns.

In an embodiment, the multilayer film is a coextruded three layer film (single core layer).

In an embodiment, the multilayer film is a coextruded five layer film, with three core layers. The core layers may be the same or different.

In an embodiment, the multilayer film is a coextruded seven layer film, with five core layers. The core layers may be the same or different.

### 2. Flexible Container

The present disclosure provides a flexible container. In an embodiment, the flexible container includes

A. a front panel, a rear panel, a first gusseted side panel, and a second gusseted side panel, the gusseted side panels adjoining the front panel and the rear panel along peripheral seals to form a chamber, each panel is a multilayer film having at least three layers, each multilayer film comprising
(i) an outermost layer comprising a high density polyethylene (HDPE) having a density from greater than 0.94 g/cc to 0.98 g/cc,
(ii) a core layer comprising a core ethylene-based polymer having a density from 0.908 g/cc to less than 0.93 g/cc,
(iii) an innermost seal layer comprising a seal ethylene-based polymer having a density from 0.86 g/cc to 0.92 g/cc; and

B. each panel includes a bottom face comprising two opposing peripheral tapered seals, each peripheral tapered seal extending from a respective peripheral seal.

The multilayer film can be a multilayer film as previously disclosed herein. In an embodiment, the bottom faces form a base segment, and the base segment supports the flexible container in a free-standing upright position on a flat surface bottom faces form a base segment. The base segment supports the flexible container in a free-standing upright position on a flat surface.

In an embodiment, the flexible container has a volume from 1 liter to 20 liters and the flexible container passes the vertical drop test. In a further embodiment, the flexible container also passes the side drop test.

In an embodiment, the flexible container includes components (A)-(E) described below.

A. A front panel, a rear panel, a first gusseted side panel, and a second gusseted side panel, the gusseted side panels adjoining the front panel and the rear panel along peripheral seals to form a chamber. Each panel is a multilayer film having at least three layers, each multilayer film comprising
(i) an outermost layer comprising a HDPE,
(ii) a core layer comprising a core ethylene-based polymer having a density from 0.908 g/cc to less than 0.93 g/cc, and
(iii) an innermost seal layer comprising a seal ethylene-based polymer having a density from 0.86 g/cc to 0.92 g/cc. The multilayer film can be any multilayer film as previously disclosed herein.

B. Each panel includes a bottom segment comprising two opposing peripheral tapered seals, each peripheral tapered seal extending from a respective peripheral seal, each peripheral tapered seal comprising an inner edge, the peripheral tapered seals converging at a bottom seal area.

C. The front panel bottom segment includes a first line defined by the inner edge of the first peripheral tapered seal and a second line defined by the inner edge of the second peripheral tapered seal, the first line intersecting the second line at an apex point in the bottom seal area.

D. The front panel bottom segment has a bottom distalmost inner seal point on the inner edge.

E. The apex point is separated from the bottom distalmost inner seal point by a distance from 0 mm to less than 8.0 mm.

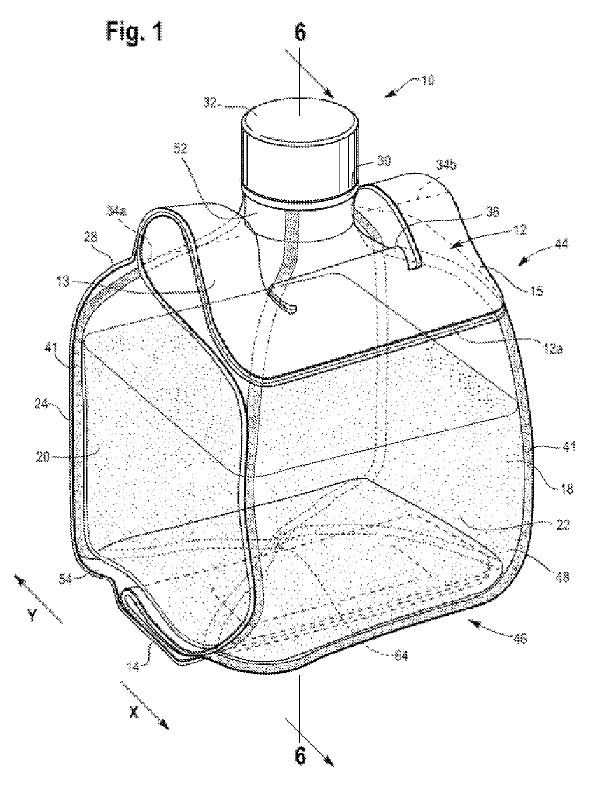

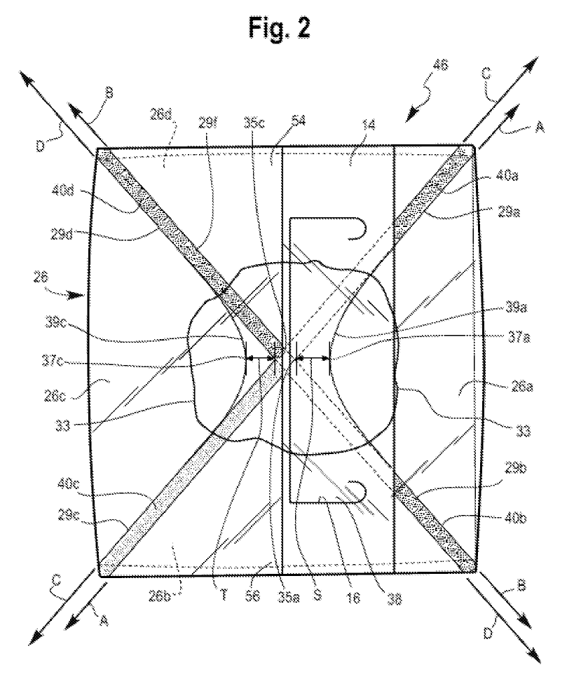

FIGS. 1-2 show a flexible container 10 having a flexible top 12 and a bottom 14. The flexible container 10 has four panels, a front panel 22, a back panel 24, a first gusset panel 18 and a second gusset panel 20. Each panel is composed of the present multilayer film. The multilayer film can be any multilayer film as previously disclosed herein. The four panels 18, 20, 22, and 24 extend toward a top end 44 and a bottom end 46 of the container 10 to form the top segment 28 and bottom segment 26, respectively. When the container 10 is inverted, the top and bottom positions in relation to the container 10 change. However, for consistency the handle adjacent the spout 30 will be called the top or upper handle 12 and the opposite handle will be called the bottom or lower handle 14. Likewise, the top or upper portion, segment or panel will be the surface adjacent the spout 30, and the bottom or lower portion, segment, or panel will be the surface opposite the top segment.

The four panels 18, 20, 22 and 24 each can be composed of a separate web of film. The composition and structure for each web is the present multilayer film having at least three layers as previously disclosed herein. Alternatively, one web of film may also be used to make all four panels and the top and bottom segments. In a further embodiment, two or more webs can be used to make each panel.

In an embodiment, four webs of film are provided, one web of film for each respective panel 18, 20, 22, and 24. The film is any of the present multilayer films having at least three layers as previously disclosed herein. The edges of each film are sealed to the adjacent web of film to form peripheral seals 41 (FIG. 1). The peripheral tapered seals 40a-40d are located on the bottom segment 26 of the container as shown in FIG. 2. The peripheral seals 41 are located on the side edges of the container 10.

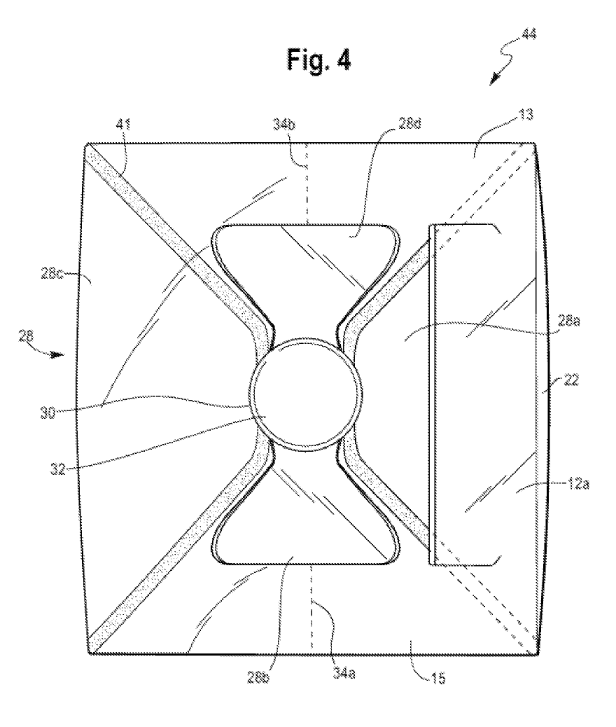

To form the top segment 28 and the bottom segment 26, the four webs of the present multilayer film converge together at the respective end and are sealed together. For instance, the top segment 28 can be defined by extensions of the panels sealed together at the top end 44 and when the container 10 is in a rest position it can have four top panels 28a-28d (FIG. 4) of the present multilayer film that define the top segment 28. The bottom segment 26 can also have four bottom panels 26a-26d of film sealed together and can also be defined by extensions of the panels at the opposite end 46 as shown in FIG. 2.

In an embodiment, a portion of the four webs of the multilayer film 28 that make up the top segment 28 form a neck. The neck can be sealed. The neck seal can be a tear seal. Alternatively, the neck seal can be a re-sealable seal. Nonlimiting examples of suitable re-sealable seals include peelable seal, a flap seal, an adhesive seal, and a zipper seal.

In an embodiment, a portion of the four webs of the multilayer film that make up the top segment 28 terminate at a spout 30. A portion of a top end section of each of the four webs of film is sealed, or otherwise welded, to an outer, lower rim 52 of the spout 30 to form a tight seal. The spout is sealed to the flexible container by way of compression heat seal, ultrasonic seal, and combinations thereof. Although the base of spout 30 has a circular cross-sectional shape, it is understood that the base of spout 30 can have other cross-sectional shapes such as a polygonal cross-sectional shape, for example. The base with circular cross-sectional shape is distinct from fitments with canoe-shaped bases used for conventional two-panel flexible pouches.

In an embodiment, the outer surface of the base of spout 30 has surface texture. The surface texture can include embossment and a plurality of radial ridges to promote sealing to the inner surface of the top segment 28.

In an embodiment, the spout 30 excludes fitments with oval, wing-shaped, eye-shaped, or canoe-shaped bases.

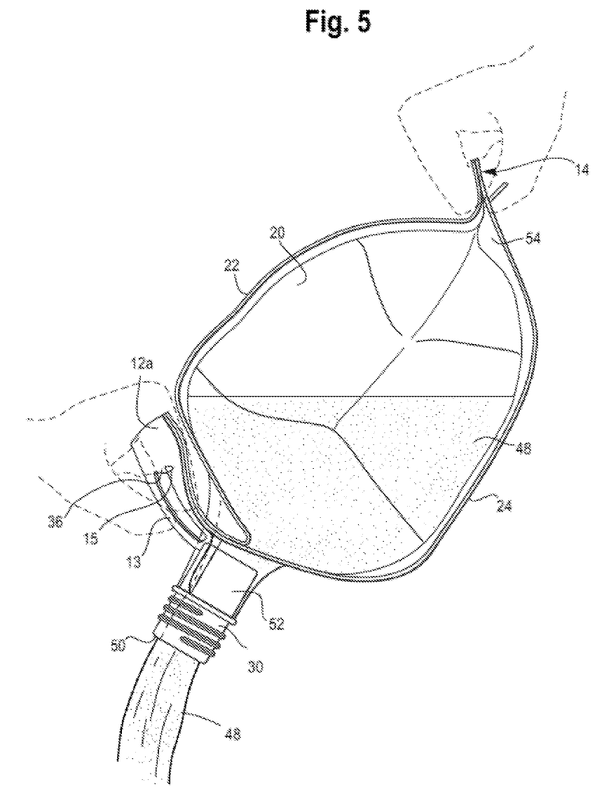

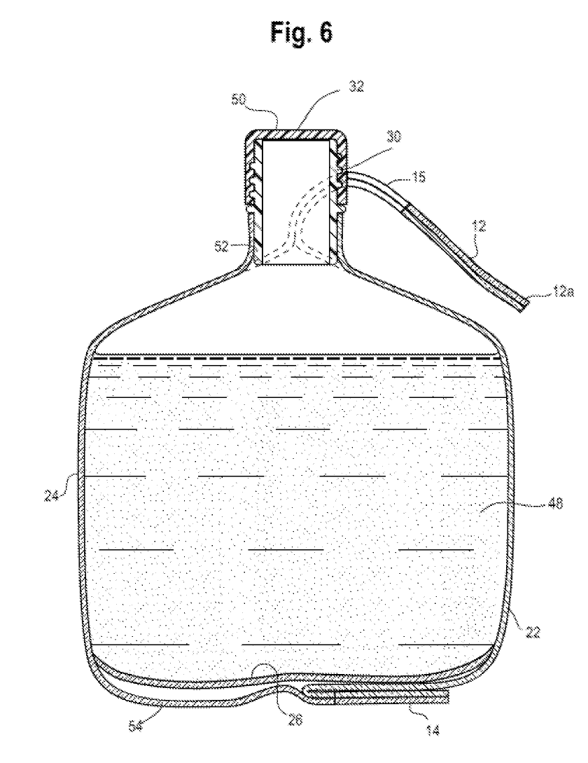

Furthermore, the spout 30 can contain a removable closure 32. The spout 30 has an access opening 50 through the top segment 28 to the interior as shown in FIGS. 5-6. Alternatively, the spout 30 can be positioned on one of the panels, where the top segment would then be defined as an upper seal area defined by the joining together of at least two panel ends. In a further embodiment, the spout 30 is positioned at generally a midpoint of the top segment 28 and can be sized smaller than a width of the container 10, such that the access opening 50 of the spout 30 can have an area that is less than a total area of the top segment 28. In yet a further embodiment, the spout area is not more than 20% of the total top segment area. This can ensure that the spout 30 and its associated access opening 50 will not be large enough to insert a hand therethrough, thus avoiding any unintentional contact with the product 58 stored therein.

The spout 30 can be made of a rigid construction and can be formed of any appropriate plastic, such as high density polyethylene (HDPE), olefin block copolymer (OBC) or low density polyethylene (LDPE), and combinations thereof. The location of the spout 30 can be anywhere on the top segment 28 of the container 10. In an embodiment the spout 30 is located at the center or midpoint of the top segment 28. The closure 32 covers the access opening 50 and prevents the product from spilling out of the container 10. The cap 32 may be a screw-on cap, a flip-top cap or other types of removable (and optionally reclosable) closures. In an embodiment, the spout can be a flange style fitment installed in a hole of any one panel.

As shown in FIGS. 1-2, the flexible bottom handle 14 can be positioned at a bottom end 46 of the container 10 such that the bottom handle 14 is an extension of the bottom segment 26.

Each panel includes a respective bottom face. FIG. 2 shows four triangle-shaped bottom faces 26a, 26b, 26c, 26d, each bottom face being an extension of a respective film panel. The bottom faces 26a-26d make up the bottom segment 26. The four panels 26a-26d come together at a midpoint of the bottom segment 26. The bottom faces 26a-26d are sealed together, such as by using a heat-sealing technology, to form the bottom handle 14. For instance, a weld can be made to form the bottom handle 14, and to seal the edges of the bottom segment 26 together. Nonlimiting examples of suitable heat-sealing technologies include hot bar sealing, hot die sealing, impulse sealing, high frequency sealing, or ultrasonic sealing methods.

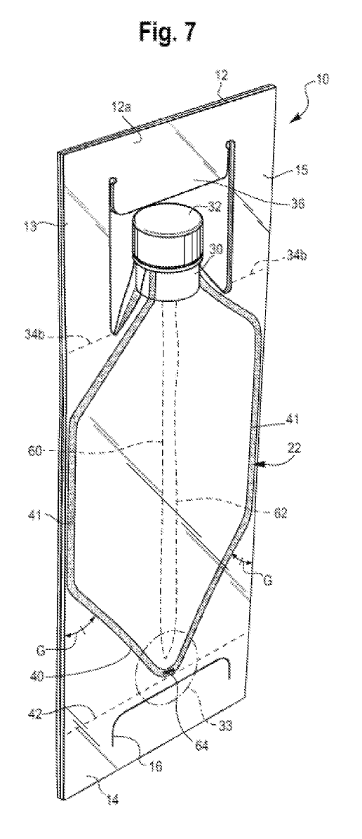

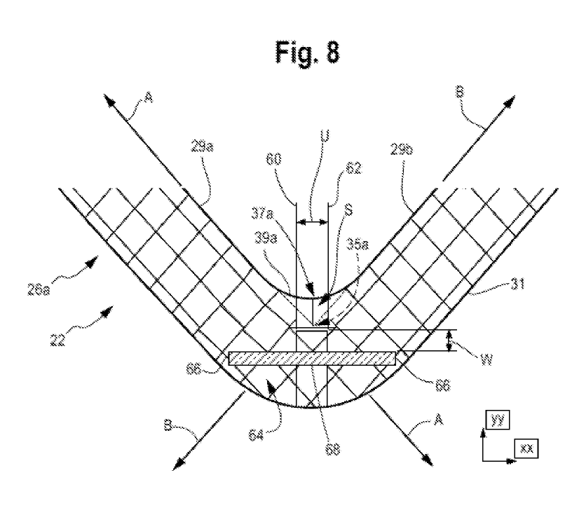

FIG. 2 shows bottom segment 26. Each panel 18, 20, 22, 24 has a respective bottom face 26a-26d that is present in the bottom segment 26. Each bottom face is bordered by two opposing peripheral tapered seals 40a, 40b, 40c, 40d. Each peripheral tapered seal 40a-40d extends from a respective peripheral seal 41. The peripheral tapered seals for the front panel 22 and the rear panel 24 have an inner edge 29a-29d (FIG. 2) and an outer edge 31 (FIG. 8). The peripheral tapered seals 40a-40d converge at a bottom seal area 33 (FIG. 2, FIG. 7, FIG. 8).

The front panel bottom face 26a includes a first line A defined by the inner edge 29a of the first peripheral tapered seal 40a and a second line B defined by the inner edge 29b of the second peripheral tapered seal 40b. The first line A intersects the second line B at an apex point 35a in the bottom seal area 33. The front panel bottom face 26a has a bottom distalmost inner seal point 37a (“BDISP 37a”). The BDISP 37a is located on an inner seal edge defined by inner edge 29a and inner edge 29b.

The apex point 35a is separated from the BDISP 37a by a distance S from 0 millimeter (mm), or greater than 0 mm to less than 8.0 mm.

In an embodiment, the rear panel bottom face 26c includes an apex point similar to the apex point on the front panel bottom face. The rear panel bottom face 26c includes a first line C defined by the inner edge of the 29c first peripheral tapered seal 40c and a second line D defined by the inner edge 29d of the second peripheral tapered seal 40d. The first line C intersects the second line D at an apex point 35c in the bottom seal area 33. The rear panel bottom face 26c has a bottom distalmost inner seal point 37c (“BDISP 37c”). The BDISP 37c is located on an inner seal edge defined by inner edge 29c and inner edge 29d. The apex point 35c is separated from the BDISP 37c by a distance T from 0 millimeter (mm), or greater than 0 mm to less than 8.0 mm.

It is understood the following description to the front panel bottom face applies equally to the rear panel bottom face, with reference numerals to the rear panel bottom face shown in adjacent closed parentheses.

In an embodiment, the BDISP 37a (37c) is located where the inner edges 29a (29c) and 29b (29d) intersect. The distance between the BDISP 37a (37c) and the apex point 35a (35c) is 0 mm.

In an embodiment, the inner seal edge diverges from the inner edges 29a, 29b (29c, 29d), to form a distal inner seal arc 39a (front panel) a distal inner seal arc 39c (rear panel) as shown in FIGS. 2 and 8. The BDISP 37a (37c) is located on the inner seal arc 39a (39c). The apex point 35a (apex point 35c) is separated from the BDISP 37a (BDISP 37c) by the distance S (distance T) which is from greater than 0 mm, or 1.0 mm, or 2.0 mm, or 2.6 mm, or 3.0 mm, or 3.5 mm, or 3.9 mm, to 4.0 mm, or 4.5 mm, or 5.0 mm, or 5.2 mm, or 5.3 mm, or 5.5 mm, or 6.0 mm, or 6.5 mm, or 7.0 mm, or 7.5 mm, or 7.9 mm.

In an embodiment, apex point 35a (35c) is separated from the BDISP 37a (37c) by the distance S (distance T) which is from greater than 0 mm to less than 6.0 mm.

In an embodiment, the distance from S (distance T) from the apex point 35a (35c) to the BDISP 37a (37c) is from greater than 0 mm, or 0.5 mm or 1.0 mm, or 2.0 mm to 4.0 mm or 5.0 mm or less than 5.5 mm.

In an embodiment, apex point 35a (apex point 35c) is separated from the BDISP 37a (BDISP 37c) by the distance S (distance T) which is from 3.0 mm, or 3.5 mm, or 3.9 mm, to 4.0 mm, or 4.5 mm, or 5.0 mm, or 5.2 mm, or 5.3 mm, or 5.5 mm.

In an embodiment, the distal inner seal arc 39a (39c) has a radius of curvature from 0 mm, or greater than 0 mm, or 1.0 mm to 19.0 mm, or 20.0 mm.

In an embodiment, each peripheral tapered seal 40a-40d (outside edge) and an extended line from respective peripheral seal 41 (outside edge) form an angle G as shown in FIG. 7. The angle G is from 40° or 42°, or 44°, or 45° to 46°, or 48, or 50°. In an embodiment, angle G is 45°.

The bottom segment 26 includes a pair of gussets 54 and 56 formed thereat, which are essentially extensions of the bottom faces 26a-26d. The gussets 54 and 56 can facilitate the ability of the flexible container 10 to stand upright. These gussets 54 and 56 are formed from excess material from each bottom face 26a-26d that are joined together to form the gussets 54 and 56. The triangular portions of the gussets 54 and 56 comprise two adjacent bottom segment panels sealed together and extending into its respective gusset. For example, adjacent bottom faces 26a and 26d extend beyond the plane of their bottom surface along an intersecting edge and are sealed together to form one side of a first gusset 54. Similarly, adjacent bottom faces 26c and 26d extend beyond the plane of their bottom surface along an intersecting edge and are sealed together to form the other side of the first gusset 54. Likewise, a second gusset 56 is similarly formed from adjacent bottom faces 26a-26b and 26b-26c. The gussets 54 and 56 can contact a portion of the bottom segment 26, where the gussets 54 and 56 can contact bottom faces 26b and 26d covering them, while bottom segment panels 26a and 26c remain exposed at the bottom end 46.

As shown in FIGS. 1-2, the gussets 54 and 56 of the flexible container 10 can further extend into the bottom handle 14. In the aspect where the gussets 54 and 56 are positioned adjacent bottom segment panels 26b and 26d, the bottom handle 14 can also extend across bottom faces 26b and 26d, extending between the pair of panels 18 and 20. The bottom handle 14 can be positioned along a center portion or midpoint of the bottom segment 26 between the front panel 22 and the rear panel 24.

The bottom handle 14 can comprise up to four layers of film sealed together when four webs of film are used to make the container 10. When more than four webs are used to make the container, the handle will include the same number of webs used to produce the container. Any portion of the bottom handle 14 where all four layers are not completely sealed together by the heat-sealing method, can be adhered together in any appropriate manner, such as by a tack seal to form a fully-sealed multi-layer bottom handle 14. The bottom handle 14 can have any suitable shape and generally will take the shape of the film end. For example, typically the web of film has a rectangular shape when unwound, such that its ends have a straight edge. Therefore, the bottom handle 14 would also have a rectangular shape.

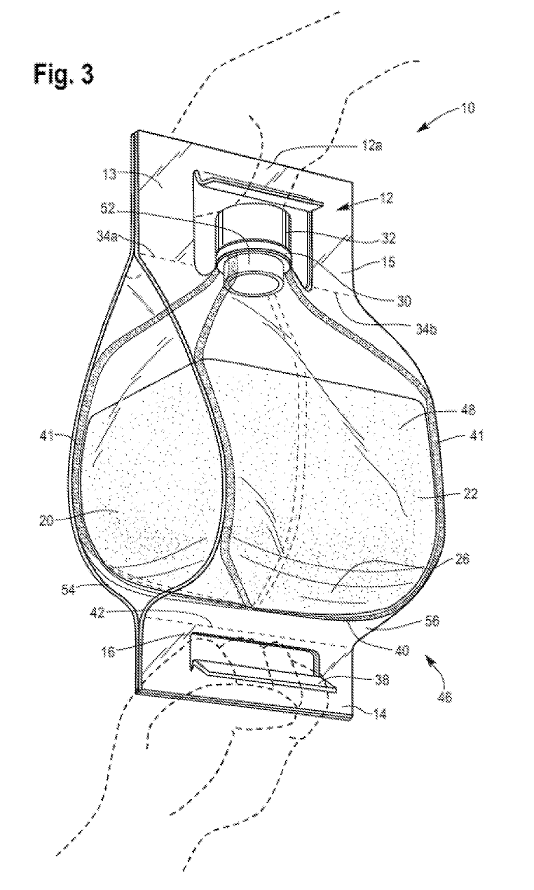

Additionally, the bottom handle 14 can contain a handle opening 16 or cutout section therein sized to fit a user's hand, as can be seen in FIG. 3. The opening 16 can be any shape that is convenient to fit the hand and, in one aspect, the opening 16 can have a generally oval shape. In another aspect, the opening 16 can have a generally rectangular shape. Additionally, the opening 16 of the bottom handle 14 can also have a flap 38 that comprises the cut material that forms the opening 16. To define the opening 16, the handle 14 can have a section that is cut out of the multilayer handle 14 along three sides or portions while remaining attached at a fourth side or lower portion. This provides a flap of material 38 that can be pushed through the opening 16 by the user and folded over an edge of the opening 16 to provide a relatively smooth gripping surface at an edge that contacts the user's hand. If the flap of material were completely cut out, this would leave an exposed fourth side or lower edge that could be relatively sharp and could possibly cut or scratch the hand when placed there.

Furthermore, a portion of the bottom handle 14 attached to the bottom segment 26 can contain a dead machine fold 42 or a score line that provides for the handle 14 to consistently fold in the same direction, as illustrated in FIGS. 1 and 3. The machine fold 42 can comprise a fold line that permits folding in a first direction toward the front side panel 22 and restricts folding in a second direction toward the rear panel 24. The term “restricts” as used throughout this application can mean that it is easier to move in one direction, or the first direction, than in an opposite direction, such as the second direction. The machine fold 42 can cause the handle 14 to consistently fold in the first direction because it can be thought of as providing a generally permanent fold line in the handle that is predisposed to fold in the first direction X, rather than in the second direction Y. This machine fold 42 of the bottom handle 14 can serve multiple purposes, one being that when a user is transferring the product from the container 10 they can grasp the bottom handle 14 and it will easily bend in the first direction X to assist in pouring. Secondly, when the flexible container 10 is stored in an upright position, the machine fold 42 in the bottom handle 14 encourages the handle 14 to fold in the first direction X along the machine fold 42, such that the bottom handle 14 can fold underneath the container 10 adjacent one of the bottom segment panels 26a, as shown in FIG. 6. The weight of the product can also apply a force to the bottom handle 14, such that the weight of the product can further press on the handle 14 and maintain the handle 14 in the folded position in the first direction X. As will be discussed herein, the top handle 12 can also contain a similar machine fold 34a-34b that also allows it to fold consistently in the same first direction X as the bottom handle 14.

Additionally, as the flexible container 10 is evacuated and less product remains, the bottom handle 14 can continue to provide support to help the flexible container 10 to remain standing upright unsupported and without tipping over. Because the bottom handle 14 is sealed generally along its entire length extending between the pair of side panels 18 and 20, it can help to keep the gussets 54 and 56 (FIG. 1, FIG. 3) together and continue to provide support to stand the container 10 upright even as the container 10 is emptied.

As seen in FIGS. 3-4, the top handle 12 can extend from the top segment 28 and, in particular, can extend from the four panels 28a-28d that make up the top segment 28. The four panels 28a-28d of film that extend into the top handle 12 are all sealed together to form a multi-layer top handle 12. The top handle 12 can have a U-shape and, in particular, an upside down U-shape with a horizontal upper handle portion 12a having a pair of spaced legs 13 and 15 extending therefrom. The legs 13 and 15 extend from the top segment 28, adjacent the spout 30 with one 13 on one side of the spout 30 and other leg 15 on the other side of the spout 30, with each leg 13, 15 extending from opposite portions of the top segment 28.

The bottommost edge of the upper handle portion 12a when extended in a position above the spout 30, can be just tall enough to clear the uppermost edge of the spout 30. A portion of the top handle 12 can extend above the spout 30 and above the top segment 28 when the handle 12 is extended in a position perpendicular to the top segment 28 and, in particular, the entire upper handle portion 12a can be above the spout 30 and the top segment 28. The two pairs of legs 13 and 15 along with the upper handle portion 12a together make up the handle 12 surrounding a handle opening that allows a user to place her hand therethrough and grasp the upper handle portion 12a of the handle 12.

As with the bottom handle 14, the top handle 12 also can have a dead machine fold 34a-34b that permits folding in a first direction toward the front side panel 22 and restricts folding in a second direction toward the rear side panel 24. The machine fold 34a-34b can be located in each leg 13, 15 at a location where the seal begins. The handle 12 can be adhered together, such as with a tack adhesive, beginning from the machine folded portion 34a-34b up to and including the horizontal upper handle portion 12a of the handle 12. The positioning of the machine fold 34a-34b can be in the same latitude plane as the spout 30 and, in particular, as the bottommost portion of the spout 30. The two machine folds 34a-34b in the handle 12 can allow for the handle 12 to be inclined to fold or bend consistently in the same first direction X as the bottom handle 14, rather than in the second direction Y. As shown in FIGS. 1 and 3, the handle 12 can likewise contain a flap portion 36, that folds upwards toward the upper handle portion 12a of the handle 12 to create a smooth gripping surface of the handle 12, as with the bottom handle 14, such that the handle material is not sharp and can protect the user's hand from getting cut on any sharp edges of the handle 12.

When the container 10 is in a rest position, such as when it is standing upright on its bottom segment 26, as shown in FIG. 1, the bottom handle 14 can be folded underneath the container 10 along the bottom machine fold 42 in the first direction X, so that it is parallel to the bottom segment 26 and adjacent bottom panel 26a, and the top handle 12 will automatically fold along its machine fold 34a-34b in the same first direction X, with a front surface of the handle 12 parallel to a top section or panel 28a of the top segment 28. The top handle 12 folds in the first direction X, rather than extending straight up, perpendicular to the top segment 28, because of the machine folds 34a-34b. Both handles 12 and 14 are inclined to fold in the same direction X, such that upon dispensing the handles can fold the same direction, relatively parallel to its respective end panel or end segment, to make dispensing easier and more controlled. Therefore, in a rest position, the handles 12 and 14 are both folded generally parallel to one another. Additionally, the flexible container 10 can stand upright even with the bottom handle 14 positioned underneath the upright flexible container 10.

Alternatively, in another aspect the flexible container can contain a fitment or pour spout positioned on a sidewall, where the top handle is essentially formed in and from the top portion or segment. The top handle can be formed from the four webs of film, each extending from its respective sidewall, extending into a sidewall or flap positioned at the top end of the container, such that the top segment of the container converges into the handle and they are one and the same, with the spout to the side of the extended handles, rather than underneath.

The material of construction of the flexible container 10 can comprise a food-grade plastic. For instance, nylon, polypropylene, polyethylene such as high density polyethylene (HDPE) and/or low density polyethylene (LDPE) may be used as discussed later. The film of the flexible container 10 can have a thickness that is adequate to maintain product and package integrity during manufacturing, distribution, product shelf life and customer usage. In an embodiment, the flexible multilayer film has a thickness from 100 micrometers, or 200 micrometers, or 250 micrometers to 300 micrometers, or 350 micrometers, or 400 micrometers. The film material can also be such that it provides the appropriate atmosphere within the flexible container 10 to maintain the product shelf life of at least about 180 days. Such films can comprise an oxygen barrier film, such as a film having a low oxygen transmission rate (OTR) from 0, or greater than 0 to 0.4, or 1.0 cc/m²/24 hrs/atm) at 23° C. and 80% relative humidity (RH). Additionally, the flexible multilayer film can also comprise a water vapor barrier film, such as a film having a low water vapor transmission rate (WVTR) from 0, or greater than 0, or 0.2, or 1.0 to 5.0, or 10.0, or 15.0 g/m²/24 hrs at 38° C. and 90% RH. OTR and WVTR are measured in accordance with ASTM E 96/E 96 M-05. Moreover, it may be desirable to use materials of construction having oil and/or chemical resistance particularly in the seal layer, but not limited to just the seal layer. The flexible multilayer film can be either printable or compatible to receive a pressure sensitive label or other type of label for displaying of indicia on the flexible container 10.

Flexible container 10 has an expanded configuration (shown in FIGS. 1-6) and a collapsed configuration as shown in FIG. 7. When the container 10 is in the collapsed configuration, the flexible container is in a flattened, or in an otherwise evacuated state. The gusset panels 18, 20 fold inwardly (dotted lines of FIG. 7) and are sandwiched by the front panel 22 and the rear panel 24.

FIG. 8 shows an enlarged view of the bottom seal area 33 of FIG. 7 and the front panel 26a. The fold lines 60 and 62 of respective gusset panels 18, 20 are separated by a distance U that is from 0 mm, or greater than 0 mm, or 0.5 mm, or 1.0 mm, or 2.0 mm to 12.0 mm, or 60 mm, or greater than 60 mm. In an embodiment, distance U varies based on the size and volume of the flexible container 10. For example, the flexible container 10 may have a distance U (in mm) that is from greater than 0 mm to three times the volume (in liters) of the container. For example, a 2-liter flexible container can have a distance U from greater than 0 to less than or equal to 6.0 mm. In another example, a 20-liter flexible container 10 has a distance U that is from greater than 0 mm to less than or equal to 60 mm.

FIG. 8 shows line A (defined by inner edge 29a) intersecting line B (defined by inner edge 29b) at apex point 35a. BDISP 37a is on the distal inner seal arc 39a. Apex point 35a is separated from BDISP 37a by distance S having a length from greater than 0 mm or 1.0 mm, or 2.0 mm, or 2.6 mm, or 3.0 mm, or 3.5 mm, or 3.9 mm to 4.0 mm, or 4.5 mm, or 5.0 mm, or 5.2 mm, or 5.5 mm, or 6.0 mm, or 6.5 mm, or 7.0 mm, or 7.5 mm, or 7.9 mm.

In FIG. 8, an overseal 64 is formed where the four peripheral tapered seals 40a-40d converge in the bottom seal area. The overseal 64 includes 4-ply portions 66, where a portion of each panel (18, 20, 22, 24) is heat sealed to a portion of every other panel. Each panel represents 1-ply in the 4-ply heat seal. The overseal 64 also includes a 2-ply portion 68 where two panels (front panel 22 and rear panel 24) are sealed together. Consequently, the “overseal,” as used herein, is the area where the peripheral tapered seals converge and that is subjected to a subsequent heat seal operation (and subjected to at least two heat seal operations altogether). The overseal 64 is located in the peripheral tapered seals and does not extend into the chamber of the flexible container 10.

In an embodiment, the apex point 35a is located above the overseal 64. The apex point 35a is separated from, and does not contact the overseal 64. The BDISP 37a is located above the overseal 64. The BDISP 37a is separated from and does not contact the overseal 64.

In an embodiment, the apex point 35a is located between the BDISP 37a and the overseal 64, wherein the overseal 64 does not contact the apex point 35a and the overseal 64 does not contact the BDISP 37a.

The distance between the apex point 35a to the top edge of the overseal 64 is defined as distance W shown in FIG. 8. In an embodiment, the distance W has a length from 0 mm, or greater than 0 mm, or 2.0 mm, or 4.0 mm to 6.0 mm, or 8.0 mm, or 10.0 mm or 15.0 mm.

When more than four webs are used to produce the container, the portion 68 of the overseal 64 may be a 4-ply, or a 6-ply, or an 8-ply portion.

In an embodiment, the flexible container 10 has a vertical drop test pass rate from 90%, or 95% to 100%. The vertical drop test is conducted as follows. The container is filled with tap water to its nominal capacity, conditioned at 25° C. for at least 3 hours, placed on a platform at 1.5 m height (from the base or side of the container to the ground), and released to a free fall drop onto a concrete slab floor. If any leak is detected immediately after the drop, the test is recorded as a failure. If no leak is detected immediately after the drop, the test is recorded as a success or “pass.” A minimum of twenty flexible containers are tested. A percentage for pass/fail containers is then calculated.

In an embodiment, the flexible container 10 has a side drop pass rate from 90%, or 95% to 100%. This side drop test is conducted as follows. The container is filled with tap water to its nominal capacity, conditioned at 25° C. for at least 3 hours, and placed on a platform with a drop mechanism. The flexible container is released on its side from a 1.5 m height to a free fall drop onto a concrete slab floor. If any leak is detected immediately after the drop, the test is recorded as failure. If no leak is detected immediately after the drop, the test is recorded as a success or “pass.” A minimum of twenty flexible containers are tested. A percentage for pass/fail containers is then calculated.

In an embodiment, the flexible container 10 passes the stand-up test where the package is filled with water at ambient temperature and placed on a flat surface for seven days. The flexible container remains in the same position, with unaltered shape or position for the seven days.

In an embodiment, the flexible container 10 has a volume from 0.25 liters (L), or 0.5 L, or 0.75 L, or 1.0 L, or 1.5 L, or 2.5 L, or 3 L, or 3.5 L, or 3.78 L or 4.0 L, or 4.5 L or 5.0 L to 6.0 L, or 7.0 L, or 8.0 L, or 9.0 L or 10.0 L, or 20 L, or 30 L.

In an embodiment, the flexible container 10 having a volume from 1 liter (L), or 1.5 L, or 2.5 L, or 3 L, or 3.5 L or 3.78 L or 4.0 L, or 4.5 L or 5.0 L to 6.0 L, or 7.0 L, or 8.0 L, or 9.0 L or 10.0 L, 15 L, or 20 L, has a vertical drop test pass rate from 90%, or 95% to 100%.

In an embodiment, In an embodiment, the flexible container 10 having a volume from 1 liter (L), or 1.5 L, or 2.5 L, or 3 L, or 3.5 L, or 3.78 L or 4.0 L, or 4.5 L or 5.0 L to 6.0 L, or 7.0 L, or 8.0 L, or 9.0 L or 10.0 L, 15 L, or 20 L, has a side drop test pass rate from 90%, or 95% to 100%.

In an embodiment, the flexible container 10 having a volume from 1 liter (L), or 1.5 L, or 2.5 L, or 3 L, or 3.5 L, or 3.78 L or 4.0 L, or 4.5 L or 5.0 L to 6.0 L, or 7.0 L, or 8.0 L, or 9.0 L or 10.0 L, 15 L, or 20 L, has a vertical drop test pass rate from 90%, or 95% to 100% and has a side drop test pass rate from 90%, or 95% to 100%.

The flexible container 10 can be used to store any number of flowable substances therein. In particular, a flowable food product can be stored within the flexible container 10. In one aspect, flowable food products such as salad dressings, sauces, dairy products, mayonnaise, mustard, ketchup, other condiments, beverages such as water, juice, milk, or syrup, carbonated beverages, beer, wine, animal feed, pet feed, and the like can be stored inside of the flexible container 10.

The flexible container 10 is suitable for storage of other flowable substances including, but not limited to, oil, paint, grease, chemicals, suspensions of solids in liquid, and solid particulate matter (powders, grains, granular solids).

The flexible container 10 is suitable for storage of flowable substances with higher viscosity and requiring application of a squeezing force to the container in order to discharge. Nonlimiting examples of such squeezable and flowable substances include grease, butter, margarine, soap, shampoo, animal feed, sauces, and baby food.

Many conventional SUPs are constructed using greater than 50 vol % of HDPE to provide adequate stiffness to the SUP geometry. The HDPE is primarily used in the inner layers and is frequently blended with other polyethylenes such as LLDPE or mLLDPE to some extent into the external layer to improve gloss.

Conventional SUPS typically place HDPE in a non-surface layer, such as the core layer.

Applicant discovered that (i) moving the HDPE to the outermost layer and (ii) reducing the amount of HDPE to less than 30 vol % surprising yields a film with sufficient stiffness for SUP production. Moving the HDPE to the outer layer also permits tougher resins to be placed in the core layers(s). Placing the HDPE in the outermost layer also enables a greater temperature differential between the innermost seal layer and outermost layer of the film, facilitating manufacture of the flexible container without outer surface sticking to tool or other outer film layer. In addition, placing the HDPE in the outermost layer reduces film damage during sealing process and widens seal windows for fitments. This provides improved seal with reduced leakage and prevents thinned film areas in the SUPs thereby improving vibration and drop resistance. The present multilayer film allows a greater portion of the film to be constructed with greater amount of more durable polymers such as ELITE™ enhanced polyethylene resins or DOWLEX™ LLDPE resins. This also helps to improve the overall durability. A surprising feature of the present flexible container, particularly at sizes between 1 liter and 20 liters, is that the flexible container has sufficient standup capability while using a film having low modulus but at same thickness (lower stiffness). Furthermore, four panel stand-up flexible containers made with the present multilayer film in volumes from 1 liter to 20 liters surprisingly pass the vertical drop test.

Some embodiments of the present disclosure will now be described in detail in the following Examples.

### EXAMPLES

### 1. Materials

Polymeric compositions for the production of multilayer films are provided in Table 1 below.

TABLE 1
RAW MATERIALS USED TO CONSTRUCT FILM EXAMPLES

| | | Density | MI (g/10 min) @ |
|---|---|---|---|
| Material | Type | (g/cc) | 190 C./2.16 kg |
| ELITE ™ 5400G | Enhanced PE | 0.916 | 1.0 |
| ELITE ™ 5401G | Enhanced PE | 0.920 | 1.0 |
| ELITE ™ 5960G | Enhanced PE* | 0.962 | 0.85 |
| AFFINITY ™ 1146G | Plastomer | 0.899 | 1.0 |
| DOWLEX ™ 5075G | LLDPE | 0.919 | 1.3 |
| AGILITY ™ 1021 | LDPE | 0.919 | 1.9 |
| Ampacet 10090 | Masterbatch - | — | — |
| (Slip agent, or | slip (5% erucamide | | |
| “slip”) | in PE) | | |
| Ampacet 10063 | Masterbatch - | — | — |
| (anti-block, or | 20% Diatomaceous | | |
| “AB”) | Earth in PE) | | |

*This resin represents the HDPE

### 2. Multilayer Film Preparation

Co-extruded blown multilayer films are produced as follows. The multilayer films are made on a Hosokawa/Alpine 7 layer blown film line equipped with seven 50 mm, grooved-feed extruders with 30:1 L/D ratio. The line is equipped with a 250 mm Alpine X die with a 2 mm die gap. The line uses Alpines Resin Miser control system and is capable of running as fast as 3.57 Kg/cm of die circumference. Table 2 shows the run conditions and parameters for the production of Example 1, Example 2, and Comparative Sample 1 (CS1).

TABLE 2
Multilayer Film Preparation - Run Conditions

| | | Example 1 | Example 2 | CS1 |
|---|---|---|---|---|
| Die Size | mm | 250 | 250 | 250 |
| diameter | | | | |
| Die Gap | mm | 2 | 2 | 2 |
| Layflat | m | 1.02 | 0.99 | 1.02 |
| Blow up Ratio | — | 2.6 | 2.5 | 2.5 |
| Gauge | microns | 178 | 152 | 179 |
| Draw Down | — | 4.32 | 5.24 | 4.32 |
| Ratio | | | | |
| Line Speed | m/minute | 9.05 | 11.0 | 8.8 |
| Output rate | Kg/cm of die | 2.3 | 2.3 | 2.3 |
| | circumference | | | |
| Throughput | Kg/hr | 182 | 181 | 182 |
| Extruder 1 | % layer | 14 | 20 | 17 |
| Extruder 2 | % layer | 14 | 12 | 12.5 |
| Extruder 3 | % layer | 14 | 12 | 12.5 |
| Extruder 4 | % layer | 14 | 12 | 12.5 |
| Extruder 5 | % layer | 15 | 12 | 12.5 |
| Extruder 6 | % layer | 15 | 12 | 18 |
| Extruder 7 | % layer | 14 | 20 | 15 |
| Extruder 1 | Temperature ° C. | 235 | 236 | 235 |
| Extruder 2 | Temperature ° C. | 239 | 242 | 235 |
| Extruder 3 | Temperature ° C. | 245 | 244 | 236 |
| Extruder 4 | Temperature ° C. | 237 | 237 | 229 |
| Extruder 5 | Temperature ° C. | 235 | 234 | 227 |
| Extruder 6 | Temperature ° C. | 241 | 243 | 244 |
| Extruder 7 | Temperature ° C. | 232 | 230 | 232 |
| Extruder 1 | Kg/hr per RPM | 0.8 | 0.78 | 0.76 |
| Extruder 2 | Kg/hr per RPM | 0.65 | 0.57 | 0.78 |
| Extruder 3 | Kg/hr per RPM | 0.48 | 0.52 | 0.77 |
| Extruder 4 | Kg/hr per RPM | 0.55 | 0.52 | 0.77 |
| Extruder 5 | Kg/hr per RPM | 0.50 | 0.55 | 0.77 |
| Extruder 6 | Kg/hr per RPM | 0.67 | 0.58 | 0.55 |
| Extruder 7 | Kg/hr per RPM | 0.68 | 0.70 | 0.67 |

The structure, composition and the properties of the multilayer films Example 1, Example 2, and Comparative Sample 1 (CS1) are provided in Table 3 below.

TABLE 3
Multilayer film compositions

| Example 1 | | | Example 2 | | | CS1 | | |
|---|---|---|---|---|---|---|---|---|
| Total | | | Total | | | Total | | |
| Gauge | 175 | μm | Gauge | 150 | μm | Gauge | 114 | μm |
| Target | Wt % | Component | Target | Wt % | Component | Target | Wt % | Component |
| Layer 1 | 82.00% | Elite 5960G | Layer 1 | 82.00% | Elite 5960G | Layer 1 | 85.00% | Dowlex 5075G |
| | | (HDPE) | | | (HDPE) | | | |
| | 15.00% | Agility 1021 | | 15.00% | Agility 1021 | | 15.00% | Agility 1021 |
| | 2.00% | Slip 10090 | | 2.00% | Slip 10090 | | | |
| | 1.00% | AB 10063 | | 1.00% | AB 10063 | | | |
| Layer 2 | 99.00% | Elite 5400G | Layer 2 | 99.00% | Elite 5400G | Layer 2 | 100.00% | Elite 5401G |
| | 1.00% | 10090 Slip | | 1.00% | Slip 10090 | | | |
| Layer 3 | 100.00% | Elite 5400G | Layer 3 | 100.00% | Elite 5400G | Layer 3 | 100.00% | Elite 5960G |
| | | | | | | | | (HDPE) |
| Layer 4 | 100.00% | Elite 5400G | Layer 4 | 100.00% | Elite 5400G | Layer 4 | 100.00% | Elite 5960G |
| | | | | | | | | (HDPE) |
| Layer 5 | 100.00% | Elite 5400G | Layer 5 | 100.00% | Elite 5400G | Layer 5 | 100.00% | Elite 5960G |
| | | | | | | | | (HDPE) |
| Layer 6 | 84.00% | Elite 5400G | Layer 6 | 84.00% | Elite 5400G | Layer 6 | 100.00% | Elite 5960G(HDPE) |
| | 15.00% | Agility 1021 | | 15.00% | Agility 1021 | | | |
| | 1.00% | 10090 Slip | | 1.00% | Slip 10090 | | | |
| Layer 7 | 95.00% | Affinity 1146G | Layer 7 | 95.00% | Affinity 1146G | Layer 7 | 95.00% | Affinity 1146G |
| | 1.00% | Slip 10090 | | 1.00% | Slip 10090 | | 1.00% | Slip 10090 |
| | 4.00% | AB 10063 | | 4.00% | AB 10063 | | 4.00% | AB 10063 |
| Overall | Volume % | Thickness | Overall | Volume % | Thickness | Overall | Volume % | Thickness |
| Layer 1 | 14.00% | 0.98 | Layer 1 | 20.00% | 1.2 | Layer 1 | 14.00% | 0.63 |
| Layer 2 | 14.00% | 0.98 | Layer 2 | 12.00% | 0.72 | Layer 2 | 14.00% | 0.63 |
| Layer 3 | 14.00% | 0.98 | Layer 3 | 12.00% | 0.72 | Layer 3 | 14.00% | 0.63 |
| Layer 4 | 14.00% | 0.98 | Layer 4 | 12.00% | 0.72 | Layer 4 | 14.00% | 0.63 |
| Layer 5 | 15.00% | 1.05 | Layer 5 | 12.00% | 0.72 | Layer 5 | 15.00% | 0.68 |
| Layer 6 | 15.00% | 0.98 | Layer 6 | 12.00% | 0.72 | Layer 6 | 14.00% | 0.63 |
| Layer 7 | 14.00% | 1.05 | Layer 7 | 20.00% | 1.2 | Layer 7 | 15.00% | 0.68 |

The properties of the multilayer films Example 1, Example 2, and Comparative Sample 1 (CS1) are provided in Table 4 below.

TABLE 4
Multilayer film properties

| Property | Example 1 | Example 2 | CS1 |
|---|---|---|---|
| Thickness, μm | 184 | 155 | 170 |
| 2% Secant Modulus, MD, MPa | 217.7 | 259.4 | 420.8 |
| 2% Secant Modulus, CD,, MPa | 203.6 | 251.2 | 452.3 |
| Tensile, Break, MD, MPa | 27.7 | 33.4 | 20.7 |
| Tensile % E at Break, MD | 906 | 825 | 445 |
| Tensile, Energy to Break, MD, J | 35 | 28 | 16 |
| Tensile Yield Stress, MD, MPa | 11.3 | 11.6 | 19.4 |
| Tensile % E at Yield, MD | 21.6 | 17.0 | 7.0 |
| Tensile, Break, CD, MPa | 28.9 | 33.4 | 20.4 |
| Tensile % E at Break, CD | 963 | 802 | 487 |
| Tensile Yield Stress, CD, MPa | 11.2 | 11.4 | 18.9 |
| Tensile % E at Yield, CD | 17.9 | 15.2 | 7.1 |
| Tensile, Energy to Break, CD, J | 39 | 25 | 17 |
| Drop test, m | 1.67, pass | 1.52, pass | 0.8, fail |
| Elmendorf CD, N/25 μm | 5.0 | 5.6 | 1.9 |
| Elmendorf MD, N/25 μm | 4.4 | 4.1 | 1.3 |

### 3. Flexible Containers and Vertical Drop Test

Flexible containers (SUPS) are produced with design and geometry as shown in FIGS. 1-8 using a plate sealer for 3.78 Liter sized container and are sealed at 152° C., 6 second dwell time with a seal die pressure of 7.2 bar.

Flexible containers are drop tested after filling with 3.78 liters of water and tightening the screw cap closure. A drop tower is used to drop from various heights up to 1.68 meters and using ASTM D2463 standard test method for drop impact resistance. Failure is defined as any rupture visible to an observer or any evidence of container contents outside of the container. The drop time is the time after the fall is initiated and video trigger is activated until the largest force of the container hits the bottom plate. The force is the actual load recorded when the container hits the plate. If the container hits on one edge first and not flat the drop time will change. When bottles bounce, multiple readings occur with the first hit usually having the biggest load. Pass-Fail is used to signify performance at a given height as shown in Tables 4A-4C.

Tables 4A-4C. Drop test results for 3.78 liters flexible container filled with water

TABLE 4A
Example 1

| Bottom | Drop height | pass/ | drop time | Force |
|---|---|---|---|---|
| Drop Test | meters | fail | miliseconds | N |
| 1 | 0.914 | pass | 0.41 | 1939 |
| 2 | 1.067 | pass | 0.46 | 1592 |
| 3 | 1.219 | pass | 0.482 | 1455 |
| 4 | 1.372 | pass | 0.523 | 1544 |
| 5 | 1.524 | pass | 0.148 | 2673 |
| 6 | 1.676 | pass | 0.563 | 2175 |
| 7 | 1.676 | pass | 0.578 | 1819 |
| 8 | 1.676 | pass | 0.578 | 2068 |

TABLE 4B
Example 2

| Bottom | drop height | pass/ | drop time | Force |
|---|---|---|---|---|
| Drop Test | m | fail | miliseconds | N |
| 1 | 1.219 | pass | 0.482 | 1926 |
| 2 | 1.219 | pass | 0.471 | 2326 |
| 3 | 1.372 | pass | 0.162 | 2798 |
| 4 | 1.372 | pass | 0.516 | 2059 |
| 5 | 1.372 | pass | 0.142 | 6427 |
| 6 | 1.524 | pass | 0.144 | 4768 |
| 7 | 1.524 | pass | 0.54 | 6685 |

TABLE 4C
CS1

| Bottom | Drop height | pass/ | drop time | Force | |
|---|---|---|---|---|---|
| Drop Test | meters | fail | miliseconds | N | notes |
| 1 | 0 | fail | NA | NA | failed during |
| | | | | | filling |
| 2 | 0.825 | fail | 0.388 | 1227 | Pass would have |
| | | | | | to be lower than |
| | | | | | 0.825 meter but |
| | | | | | not determined |

It is specifically intended that the present disclosure not be limited to the embodiments and illustrations contained herein, but include modified forms of those embodiments including portions of the embodiments and combinations of elements of different embodiments as come with the scope of the following claims.

1. A flexible container comprising:
A. a front panel, a rear panel, a first gusseted side panel, and a second gusseted side panel, the gusseted side panels adjoining the front panel and the rear panel along peripheral seals to form a chamber, each panel is a multilayer film having at least three layers, each multilayer film comprising
(i) an outermost layer comprising a high density polyethylene (HDPE) having a density from greater than 0.94 g/cc to 0.98 g/cc,
(ii) a core layer comprising a core ethylene-based polymer having a density from 0.908 g/cc to less than 0.93 g/cc,
(iii) an innermost seal layer comprising a seal ethylene-based polymer having a density from 0.86 g/cc to 0.92 g/cc; and
B. each panel includes a bottom face comprising two opposing peripheral tapered seals, each peripheral tapered seal extending from a respective peripheral seal.

2. The flexible container of claim 1 wherein the seal ethylene-based polymer has a first melt temperature, Tm1, less than 105° C.;
the HDPE has a second melt temperature, Tm2; and
Tm2-Tm1 is from 20° C. to 50° C.

3. The flexible container of claim 1 wherein each multilayer film contains from 5 vol % to 45 0 vol % of the HDPE.

4. The flexible container of claim 1 wherein the core ethylene-based polymer has a density from 0.912 g/cc, 0.929 g/cc.

5. The flexible container of claim 1 wherein each multilayer film comprises
(i) an outermost layer comprising a HDPE having a melt index from 0.5 g/10 min to 1.5 g/10 min,
(ii) a core layer comprising an ethylene/C₄-C₈ α-olefin copolymer having a density from 0.91 g/cc to less than 0.93 g/cc and a melt index from 0.5 g/10 min to 1.5 g/10 min, and
(iii) an innermost seal layer comprising an ethylene/C₄-C₈ α-olefin copolymer having a density from 0.88 g/cc to less than 0.91 g/cc and a melt index from 0.5 g/10 min to 1.5 g/10 min.

6. The flexible container of claim 1 wherein each multilayer film has a thickness from 100 microns to 250 microns and has a 2% secant modulus from 200 MPa to 350 MPa.

7. The flexible container of claim 6 wherein each multilayer film has tensile energy to break from 20 Joules to 40 Joules.

8. The flexible container of claim 7 wherein each multilayer film has an Elmendorf tear strength from 4.0 N/25 microns to 8.0 N/25 microns.

9. The flexible container of claim 1 wherein the bottom faces form a base segment; and
the base segment supports the flexible container in a free-standing upright position on a flat surface.

10. The flexible container of claim 1 wherein the flexible container has a volume from 1 liter to 20 liters and the flexible container passes the vertical drop test.

11. The flexible container of claim 10 wherein the flexible container passes the side drop test.

12. The flexible container of claim 1 wherein each peripheral tapered seal comprises an inner edge, the peripheral tapered seals converging at a bottom seal area; and
C. the front panel bottom face comprises a first line defined by the inner edge of the first peripheral tapered seal and a second line defined by the inner edge of the second peripheral tapered seal inner edge, the first line intersecting the second line at an apex point in the bottom seal area;
D. the front panel bottom face comprises a distal inner seal arc diverging from the inner edges, and a bottom distalmost inner seal point is located on the distal inner seal arc; and
E. the apex point is separated from the bottom distalmost inner seal point by a distance from greater than 0 mm to less than 8.0 mm.

13. The flexible container of claim 1 comprising a handle.

14. A flexible container comprising:
A. a front panel, a rear panel, a first gusseted side panel, and a second gusseted side panel, the gusseted side panels adjoining the front panel and the rear panel along peripheral seals to form a chamber, each panel is a multilayer film having at least three layers, each multilayer film comprising
(i) an outermost layer comprising a high density polyethylene (HDPE) having a density from greater than 0.94 g/cc to 0.98 g/cc,
(ii) a core layer comprising a core ethylene-based polymer having a density from 0.908 g/cc to less than 0.93 g/cc,
(iii) an innermost seal layer comprising a seal ethylene-based polymer having a density from 0.86 g/cc to 0.92 g/cc;
B. each panel includes a bottom face comprising two opposing peripheral tapered seals, each peripheral tapered seal extending from a respective peripheral seal, each peripheral tapered seal comprising an inner edge, the peripheral tapered seals converging at a bottom seal area;
C. the front panel bottom face comprises a first line defined by the inner edge of the first peripheral tapered seal and a second line defined by the inner edge of the second peripheral tapered seal inner edge, the first line intersecting the second line at an apex point in the bottom seal area;
D. the front panel bottom face has a bottom distalmost inner seal point on the inner edge; and
E. the apex point is separated from the bottom distalmost inner seal point by a distance from 0 mm to less than 8.0 mm.

15. The flexible container of claim 1 wherein the flexible container has a volume from 1 liter to 20 liters and the flexible container passes the vertical drop test.

16. The flexible container of claim 15 where the flexible container passes the side drop test.

17. The flexible container wherein the panels are adjoined to define a chamber that has a spout located on a top segment of the flexible container.

18. The flexible container of claim 14 comprising an oversea) in the bottom seal area.

19. The flexible container of claim 14 wherein each multilayer film comprises
(i) an outermost layer comprising a HDPE having a melt index from 0.5 g/10 min to 1.5 g/10 min,
(ii) a core layer comprising a core ethylene/C₄-C₈ α-olefin copolymer having a density from 0.91 g/cc to less than 0.93 g/cc and a melt index from 0.5 g/10 min to 1.5 g/10 min, and
(iii) an innermost seal layer comprising a seal ethylene/C₄-C₈ α-olefin copolymer having a density from 0.88 g/cc to less than 0.91 g/cc and a melt index from 0.5 g/10 min to 1.5 g/10 min.

20. The flexible container of claim 14 comprising a handle.
